(19) United States
(12) Patent Application Publication
(10) Pub. No.: US 2016/0254726 A1
(43) Pub. Date: Sep. 1, 2016

(54) ELECTRICITY GENERATING DEVICE

(71) Applicant: Jun Fu Clean Energy Co., Ltd., Xihu Township (TW)

(72) Inventors: Ming-Chin Chiu, Xihu Township (TW); Yung-Chien Che, Kaohsiung City (TW)

(21) Appl. No.: 15/056,214

(22) Filed: Feb. 29, 2016

Related U.S. Application Data
(63) Continuation of application No. 14/272,983, filed on May 8, 2014, now abandoned.

(30) Foreign Application Priority Data
Dec. 30, 2013 (TW) 102149014

(51) Int. Cl. H02K 7/18

(52) U.S. Cl. CPC H02K 7/1853; Y10S 74/09; H02K 53/00

(57) ABSTRACT

An electricity generating device including a base having a track, an electricity generating mechanism and a kinetic mechanism. The electricity generating mechanism includes a contact pressure assembly disposed on the track, and an electricity generating module connected to the contact pressure assembly. The electricity generating module is configured to convert mechanical energy generated by the contact pressure assembly into electrical energy. The kinetic mechanism includes at least one slider disposed on the track, and a drive assembly connected to the slider for driving the slider to continuously move along the track. The slider repeatedly rolls over the contact pressure assembly when driven by the drive assembly to continuously move along the track.

### CROSS REFERENCE TO RELATED APPLICATION

This application claims priority of Taiwanese Patent Application No. 102149014, filed on Dec. 30, 2013.

### BACKGROUND OF THE INVENTION

1. Field of the Invention

This invention relates to an electricity generating device, more particularly to an electricity generating device that converts mechanical energy into electrical energy.

2. Description of the Related Art

An existing electricity generating device generates electricity using a nuclear, thermal, solar, water, or wind power generation method. However, the aforesaid power generation method has some drawbacks. For example: the nuclear and thermal power generation methods easily cause environmental protection problems; and in the solar, water and wind power generation methods, the electricity generating device thereof must be disposed on specific places, such as a place exposed to the sun, a water reservoir or dam, and a seaside with strong winds. In view of this, an electricity generating device that generates electricity through pressing or rolling is developed.

An existing electricity generating device that generates electricity through pressing or rolling is mostly applied on the road. With the vehicles rolling over the electricity generating device, the pressure is converted into electrical energy, thereby effecting generation of electricity. Because the aforesaid electricity generating device must be buried in the road surface, the construction cost is high. Further, because the aforesaid electricity generating device is affected by the size of the traffic on the road, it cannot continuously and stably generate electricity.

### SUMMARY OF THE INVENTION

Therefore, an object of the present invention is to provide an electricity generating device having an electricity generating module which can continuously and stably generate electricity through a continuous motion of a slider of a kinetic mechanism that repeatedly rolls over a contact pressure assembly.

Another object of this invention is to provide an electricity generating device that can be disposed where required without geographic restrictions.

According to this invention, an electricity generating device comprises a base including a track, an electricity generating mechanism and a kinetic mechanism. The electricity generating mechanism includes a contact pressure assembly disposed on the track, and an electricity generating module connected to the contact pressure assembly. The electricity generating module is configured to convert mechanical energy generated by the contact pressure assembly into electrical energy. The kinetic mechanism includes at least one slider disposed on the track, and a drive assembly connected to the slider for driving the slider to continuously move along the track. The slider repeatedly rolls over the contact pressure assembly when driven by the drive assembly to continuously move along the track.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a perspective view of an electricity generating device according to the first preferred embodiment of the present invention;

FIG. 2 is a schematic top view of the first preferred embodiment;

FIG. 3 is a partial exploded perspective view of the first preferred embodiment;

FIG. 4 is an enlarged fragmentary perspective view of the first preferred embodiment, illustrating a connection between a drive member and a driven member of a drive assembly;

FIG. 5 is an enlarged fragmentary schematic bottom view of the first preferred embodiment;

FIG. 6 illustrates an assembly relation between a contact pressure assembly and an electricity generating module of the first preferred embodiment;

FIG. 7 is an enlarged fragmentary sectional view of the first preferred embodiment, illustrating a contact pressure member and a driven member in an initial position;

FIG. 8 is another sectional view of the first preferred embodiment, illustrating two opposite ends of a link rod respectively abutting against the driven member and a swing arm;

FIG. 9 is a view similar to FIG. 7, but illustrating the contact pressure member being pressed downward and the driven member being moved in the direction of an arrow (VI); FIG. 10 is a view similar to FIG. 8, but illustrating the link rod being urged by the driven member to push the swing arm to swing;

FIG. 11 is a perspective view of an electricity generating device according to the second preferred embodiment of the present invention;

FIG. 12 is a partial exploded perspective view of the second preferred embodiment;

FIG. 13 is a schematic top view of the second preferred embodiment, illustrating two sliders in a first position;

FIG. 14 is a view similar to FIG. 13, but illustrating the two sliders in a second position; and

FIG. 15 is a perspective view of an electricity generating device according to the third preferred embodiment of the present invention.

### DETAILED DESCRIPTION OF THE PREFERRED EMBODIMENTS

Before this invention is described in detail, it should be noted that, in the following description, similar elements are designated by the same reference numerals.

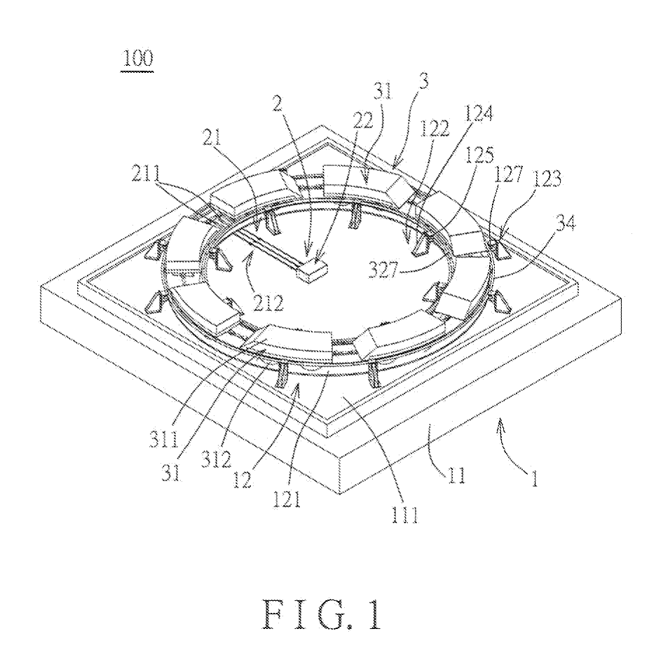

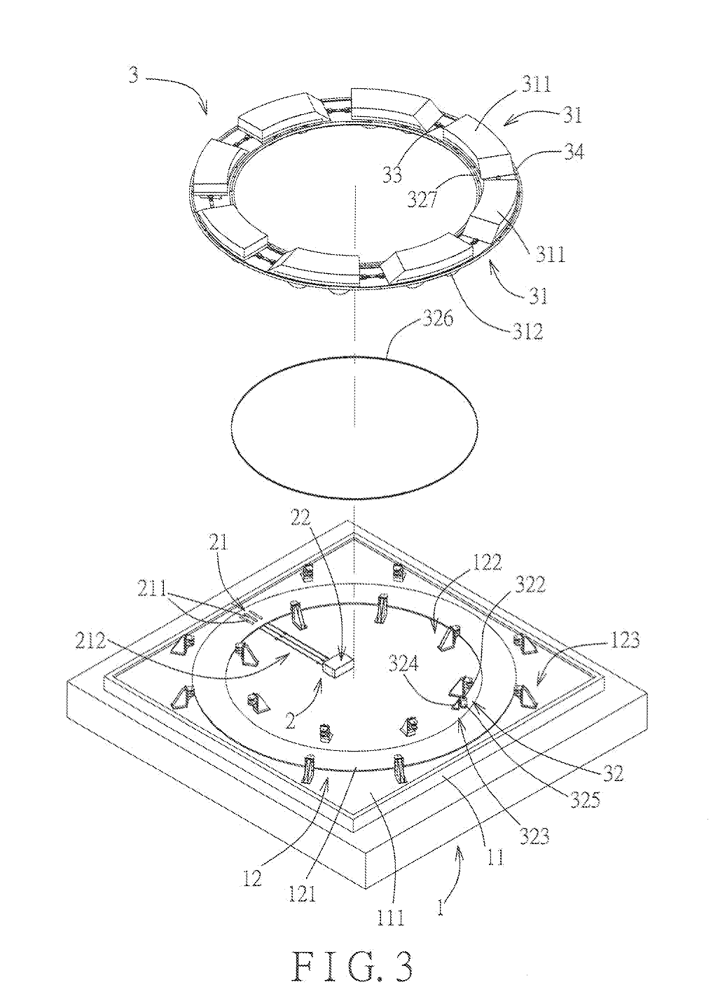

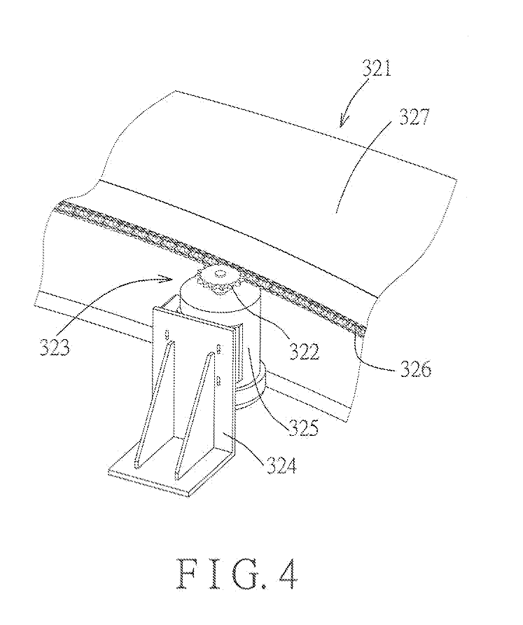

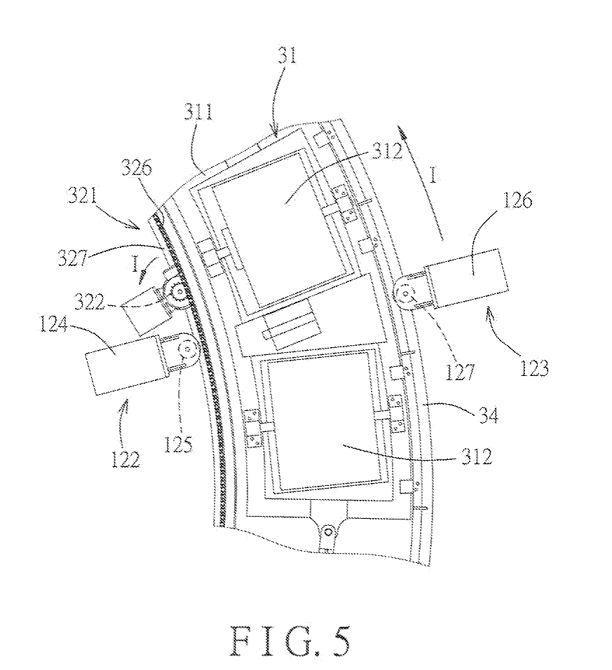

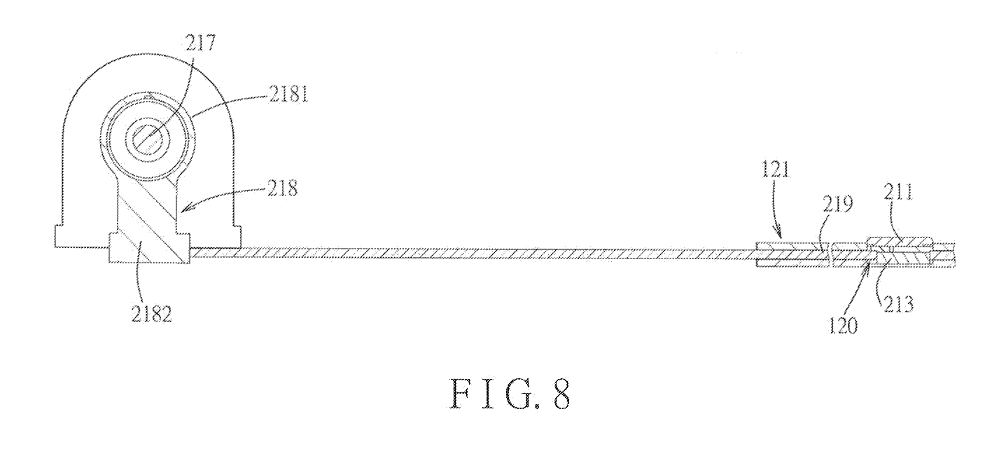

Referring to FIGS. 1 to 10, an electricity generating device 100 according to the first preferred embodiment of the present invention is shown to comprise a base 1, an electricity generating mechanism 2 and a kinetic mechanism 3.

The base 1 includes a base body 11 having a top surface 111, and a track 12 disposed on the top surface 111.

The electricity generating mechanism 2 includes a contact pressure assembly 21 and an electricity generating module 22. The contact pressure assembly 21 includes a plurality of contact pressure members 211 disposed on the track 12 for rolling over by the kinetic mechanism 3, and a plurality of transmission units 212 disposed on the top surface 111. Each transmission unit 212 is connected to a respective contact pressure member 211. The electricity generating module 22 is disposed on the top surface 111, and is connected to each transmission unit 212. The electricity generating module 22 converts mechanical energy generated by the contact pressure members 211 and the transmission units 212 into electrical energy. The electricity generating module 22 may use a transmission line (not shown) for transmitting electrical energy to a power storage device (not shown) for storing the electrical energy or to a place where electricity is to be used.

The kinetic mechanism 3 includes at least one slider 31 disposed on the track 12, and a drive assembly 32 connected to the slider 31 for driving the slider 31 to continuously move along the track 12. As such, the slider 31 can repeatedly roll over the contact pressure members 211, and the electricity generating module 22 can continuously and stably generate electricity. Hence, stability of storing or supplying electricity can be enhanced. Furthermore, because the electricity generating device 100 can generate mechanical energy through the continuous movement of the slider 31 along the track 12 to repeatedly roll over the contact pressure members 211, the electricity generating device 100 can continuously and stably generates mechanical energy and electrical energy without being affected by external environmental factors. Thus, the electricity generating device 100 can be disposed where required without geographic restrictions.

Below is a detailed description of the concrete structure and operation of the electricity generating device 100.

With reference to FIGS. 1 to 5, in this embodiment, the track 12 includes a circular flat track plate 121. The kinetic mechanism 3 includes a plurality of sliders 31 arranged angularly spaced apart from each other along the length of the track plate 121, and a plurality of connectors 33 each interconnecting two adjacent ones of the sliders 31. Each slider 31 includes a slider body 311, and a plurality of rollers 312 rotatably connected to a bottom end of the slider body 311. Each roller 312 is in contact with the track plate 121, and is rollable over each contact pressure member 211. Each connector 33 is a connecting rod pivoted to and disposed between the slider bodies 311 of each two adjacent ones of the sliders 31. It should be noted that the number of the slider 31 may be one, and is not limited to the disclosed embodiment.

The drive assembly 32 includes a driven unit 321 connected to one side of the slider body 311 of each slider 31, a drive member 322 connected to the driven unit 321, and a drive motor 323. The drive motor 323 includes a fixed frame 324 fixed to the top surface 111, and a motor body 325 disposed on the fixed frame 324 and connected to the drive member 322. The drive motor 323 drives rotation of the drive member 322, which in turn, drives rotation of the driven unit 321, thereby causing each slider 31 to move along the length of the track plate 121. Preferably, the drive member 322 is a sprocket wheel, and the driven unit 321 includes a driven member 326 in the form of a sprocket chain which is engaged with the sprocket wheel. Through coordination of the drive member 322 and the driven member 326, the drive assembly 32 can smoothly drive each slider 31 to continuously move along the track plate 121.

Concretely speaking, the driven unit 321 further includes an inner ring member 327 fixed to inner sides of the slider bodies 311 through, for example, a screw-fastening method. The driven member 326 is fixed to the inner ring member 327 through, for example, a screw-fastening method. The kinetic mechanism 3 further includes an outer ring member 34 fixed to outer sides of the slider bodies 311 through, for example, a screw-fastening method. The track 12 further includes a plurality of inner guide members 122 arranged angularly spaced apart from each other on the top surface 111 and located on an inner side of the track plate 121, and a plurality of outer guide members 123 arranged angularly spaced apart from each other on the top surface 111 and located on an outer side of the track plate 121. The inner guide members 122 are in contact with the inner ring member 327 to guide a rotational direction of the inner ring member 327. The outer guide members 123 are in contact with the outer ring member 34 to guide a rotational direction of the outer ring member 34. Through this, each slider 31 can stably move on the track plate 121, thereby ensuring that the roller 312 of each slider 31 can indeed roll over each contact pressure member 211.

Furthermore, each inner guide member 122 includes a fixed frame 124 fixed to the top surface 111, and an inner guide wheel 125 rotatably connected to the fixed frame 124 and in rolling contact with the inner ring member 327. Through this, friction between the inner guide wheel 125 and the inner ring member 327 can be reduced, so that the inner ring member 327 can smoothly rotate relative to the inner guide wheel 125 of each inner guide member 122. Each outer guide member 123 includes a fixed frame 126 fixed to the top surface 111, and an outer guide wheel 127 rotatably connected to the fixed frame 126 and in rolling contact with the outer ring member 34. Through this, friction between the outer guide wheel 127 and the outer ring member 34 can be reduced, so that the outer ring member 34 can smoothly rotate relative to the outer guide wheel 127 of each outer guide member 123.

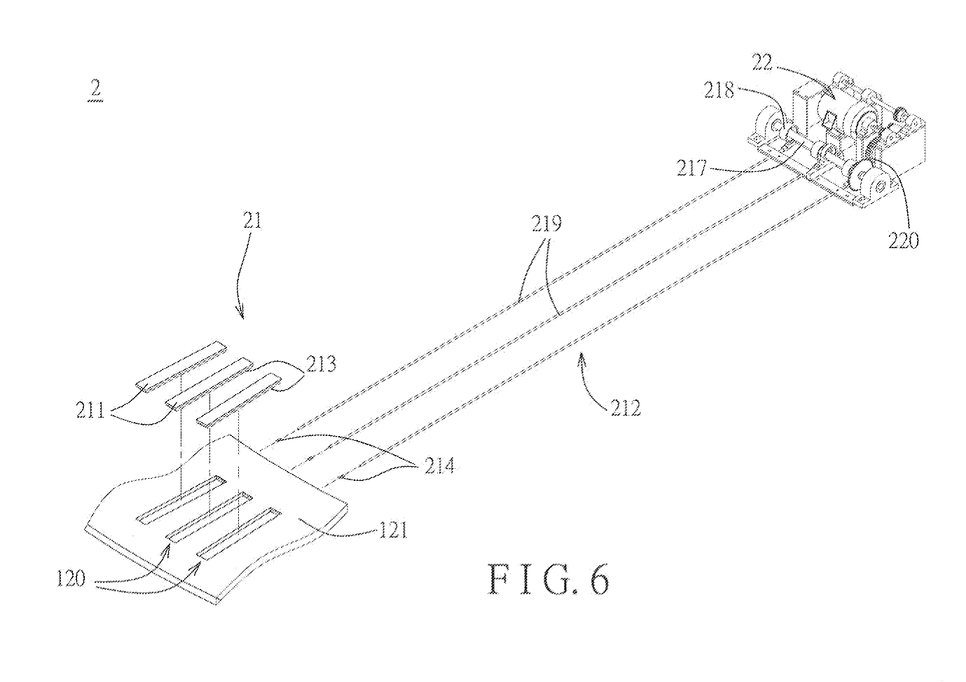

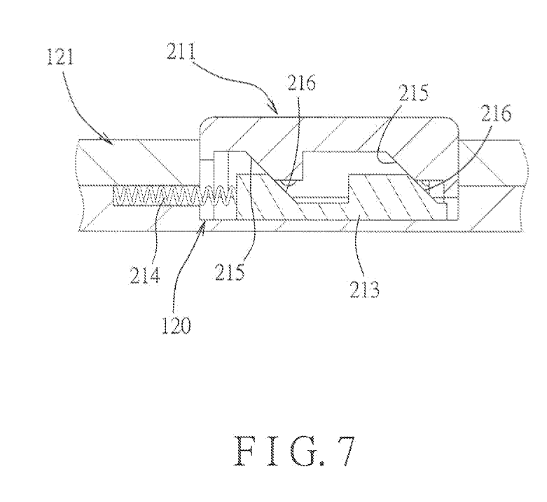

With reference to FIGS. 6 to 8, each transmission unit 212 includes a plurality of driven members 213, and a plurality of compression springs 214 disposed in the flat track plate 212 for biasing the driven members 213, respectively. The driven members 213 are disposed respectively and movably in elongated grooves 120 of the track plate 121. Each compression spring 214 is disposed in a respective groove 120 to bias the respective driven member 213 to an initial position, as shown in FIG. 7. Each contact pressure member 211 is disposed in the respective groove 120, and partially protrudes from a top surface of the track plate 121 in an initial position. Each contact pressure member 211 includes a plurality of push inclined surfaces 215 extending downwardly and inclinedly from a bottom side thereof. Each driven member 213 includes a plurality of contact inclined surfaces 216 extending upwardly and inclinedly from a top side thereof and respectively abutting against the push inclined surfaces 215.

Each transmission unit 212 further includes a rotary shaft 217, a plurality of swing arms 218, a plurality of link rods 219, and a gear set 220 disposed on the rotary shaft 217. Each swing arm 218 includes a sleeve portion 2181 sleeved on the rotary shaft 217, and a connecting portion 2182 extending downwardly from the sleeve portion 2181. Each link rod 219 has one end extending into the track plate 121 and abutting against a respective driven member 213, and another end connected to the connecting portion 2182 of a respective swing arm 218. The gear set 220 is connected to the electricity generating module 22. Through this, when the rotary shaft 217 rotates, the gear set 220 is actuated to drive operation of the electricity generating module 22 for generating electrical energy.

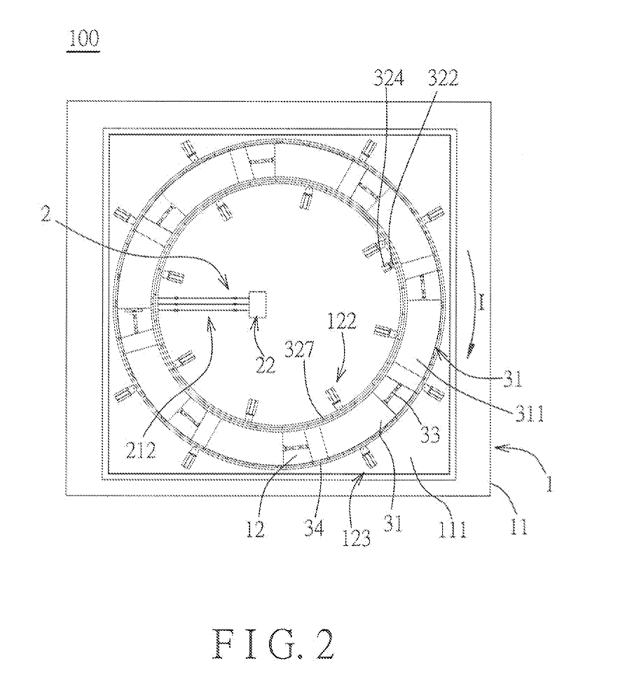

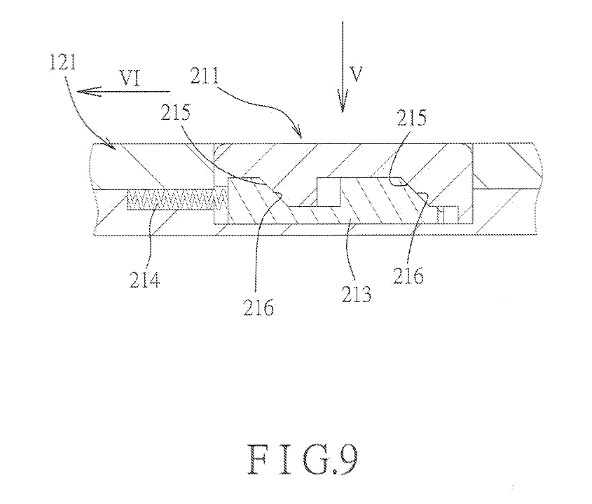

With reference to FIGS. 2, 3 and 5, when the drive motor 323 drives the drive member 322 to rotate in the direction of an arrow (I), the driven member 326 and the inner ring member 327 are simultaneously driven by the drive member 322 to rotate in the direction of the arrow (I). The inner ring member 327, in turn, drives the sliders 31 to move along the track plate 121 in the direction of the arrow (I) such that the roller 312 of each slider 31 can roll over each contact pressure member 211. With further reference to FIGS. 9 and 10, as the roller 312 of each slider 31 rolls over each contact pressure member 211, each contact pressure member 211 (only one is shown in FIGS. 9 and 10) is pressed downward in the direction of an arrow (V) from the initial position to a pressed position. At this time, a force exerted by each push inclined surface 215 on the respective contact inclined surface 216 urges the driven member 213 to move in the direction of an arrow (VI) within the receiving groove 120, thereby moving the driven member 213 from the initial position to a push position. During this time, the compression spring 214 is compressed, and the link rod 219 is pushed by the driven member 213 to move the connecting portion 2182, thereby causing the swing arm 218 to swing. Through the swinging movement of the swing arm 218 that drives the rotary shaft 217 and the gear set 220 to rotate, the electricity generating module 22 can convert the mechanical energy generated by the contact pressure assembly 21 into electrical energy. Because the sliders 31 are driven by the drive assembly 32 to continuously move along the length of the track plate 121, the roller 312 of each slider 31 can repeatedly roll over the contact pressure members 211 of the contact pressure assembly 21, so that the electricity generating module 22 can continuously and stably generates electricity. Hence, stability of storing or supplying electricity can be effectively enhanced.

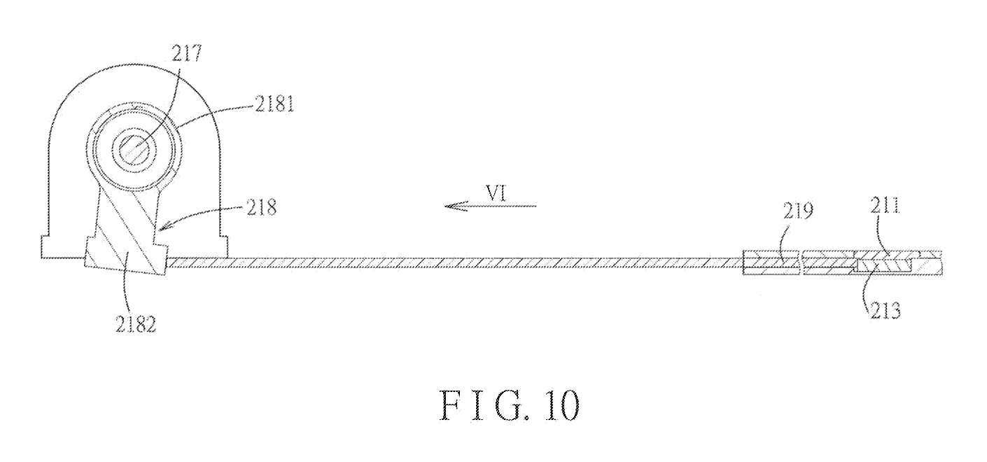

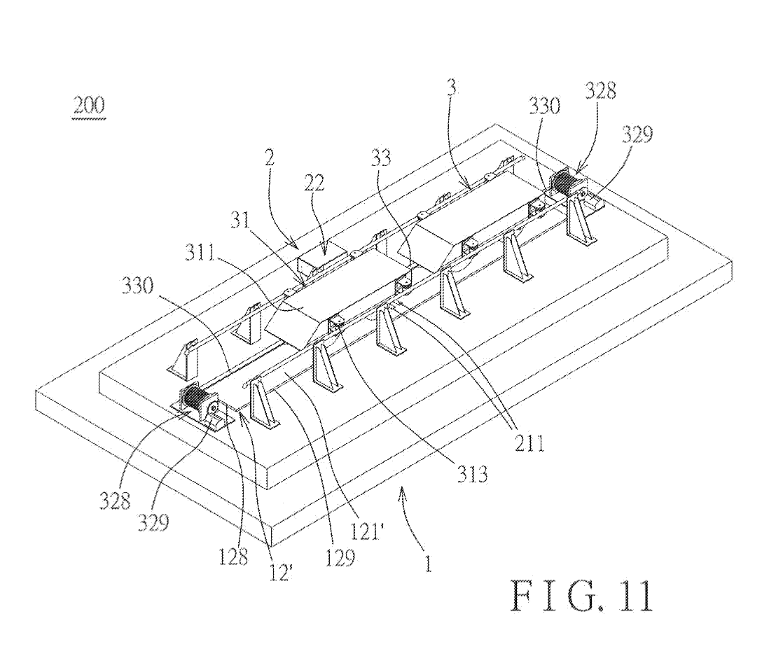

FIGS. 11 to 14 illustrate an electricity generating device 200 according to the second preferred embodiment of this invention. The electricity generating device 200 has an operating principle similar to that described in the first preferred embodiment, but has a concrete structure slightly different from that of the first preferred embodiment.

In this embodiment, the track plate 121′ of the track 12′ is elongated, and includes two opposite short sides 128 and two opposite long sides 129 connected by the short sides 128. The kinetic mechanism 3 includes two spaced-apart sliders 31 disposed on the track plate 121′, and a connector 33 in the form of a cable that is connected between the slider bodies 311 of the sliders 31. Each slider 31 has two spaced-apart rollers 312 in contact with the track plate 121′. The drive assembly 32 includes two winding devices 328 and two drive motors 329 respectively connected to the winding devices 328. The winding devices 328 are disposed on the top surface 111 of the base body 11 of the base 1, and are respectively proximate to the short sides 128. Each winding device 328 is wound with a rope 330. The rope 330 of each winding device 328 has one end wound thereon, and another end connected to one end of a respective slider body 311 opposite to the connector 33. Each drive motor 329 is used to drive rotation of the respective winding device 328 so as to move the sliders 31 along the track plate 121′ in a reciprocal manner.

The contact pressure members 211 of the contact pressure assembly 21 are located in the middle of the track plate 121′ and are spaced apart from the short sides 128. The rollers 312 of one slider 31 are located between the contact pressure members 211 and one of the short sides 128. The rollers 312 of the other slider 31 are located between the contact pressure members 211 and the other short side 128. The sliders 31 are moved linearly and reciprocally along the track plate 121′ with two adjacent rollers 312 of the sliders 31 rolling over the contact pressure members 211. Through this, moving paths of the sliders 31 can be shortened.

Moreover, the track 12′ further includes two side guide assemblies 130 disposed on the top surface 111 and respectively proximate to the long sides 129. Each side guide assembly 130 includes a guide rod 131 parallel to the respective long side 129, and a plurality of support frames 132 fixed on the top surface 111 and supporting the guide rod 131. Each slider 31 further including a plurality of side guide wheels 313 disposed on two opposite sides of the slider body 311. The side guide wheels 313 on each side of the slider body 311 are in rolling contact with a corresponding guide rod 131 so as to reduce friction between the same. Thus, each side guide wheel 313 can smoothly rotate along the corresponding guide rod 131. It should be noted that each slider 31 may have two side guide wheels 313 respectively disposed on two opposite sides of the slider body 311. The number of the side guide wheel 313 is thus not limited to the disclosed embodiment.

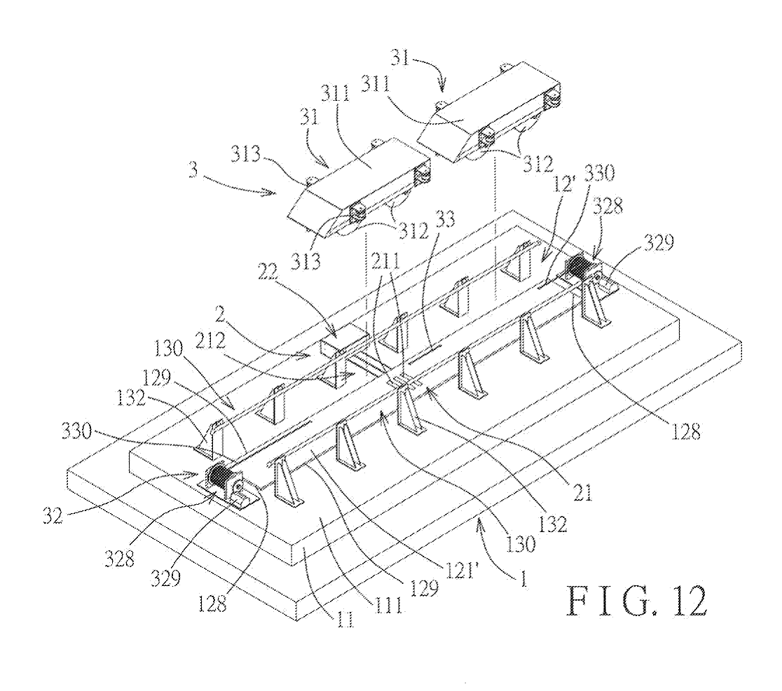

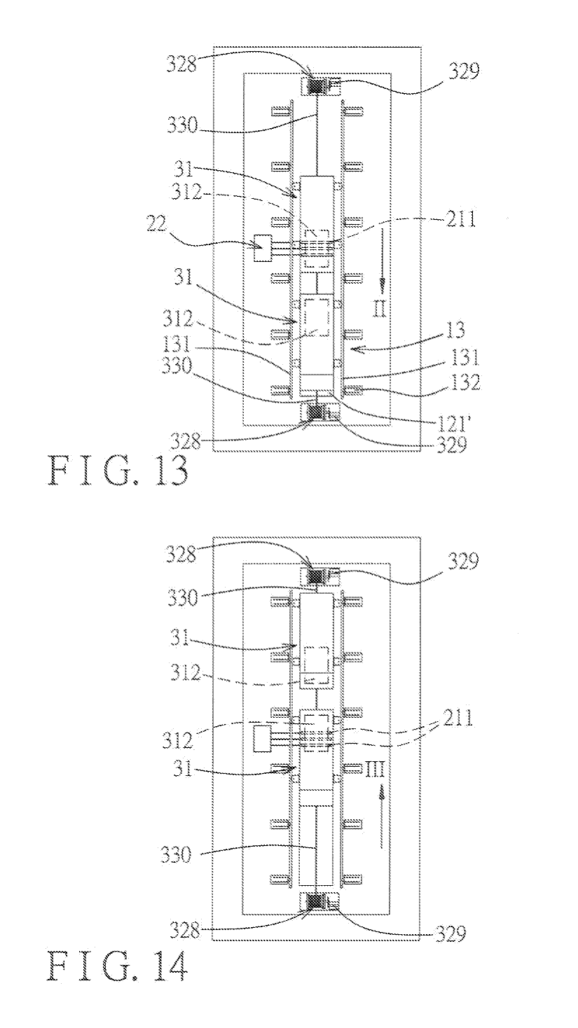

When the winding devices 328 are respectively driven by the drive motors 329 to rotate in a clockwise direction, because one of the winding devices 328 winds the rope 330, while the other winding device 328 releases the rope 330, the sliders 31 are moved linearly along the track plate 121′ from an initial position shown in FIG. 11 to a direction of an arrow (II) shown in FIG. 13. As the sliders 31 reach a first position, as shown in FIG. 13, the drive motors 329 stop driving the winding devices 328. Because one roller 312 of one of the sliders 31 is rolled over the contact pressure members 211 when the sliders 31 move from the initial position to the first position, the electricity generating module 22 can generate electrical energy. Then, when the drive motors 329 drive the respective winding devices 328 to rotate in a counterclockwise direction, the ropes 330 of the winding devices 328 move the sliders 31 from the first position to a second position, as shown in FIG. 14, in the direction of an arrow (III). As the sliders 31 reach the second position, the drive motors 329 stop driving the winding devices 328. Because two adjacent rollers 312 of the sliders 31 roll over the contact pressure members 211 one after the other when the sliders 31 move from the first position to the second position, the electricity generating module 22 can generate electrical energy. Afterwards, the drive motors 329 drive the respective winding devices 328 to rotate in the clockwise direction, and the ropes 330 drive the sliders 31 to move from the second position to the first position, so that the two adjacent rollers 312 of the sliders 31 can roll over the contact pressure members 211 once again. With the two ropes 330 moving the sliders 31 linearly and reciprocally between the first and second positions so that the two adjacent rollers 312 of the sliders 31 can repeatedly roll over the contact pressure members 211, the electricity generating module 22 can continuously and stably generate electricity.

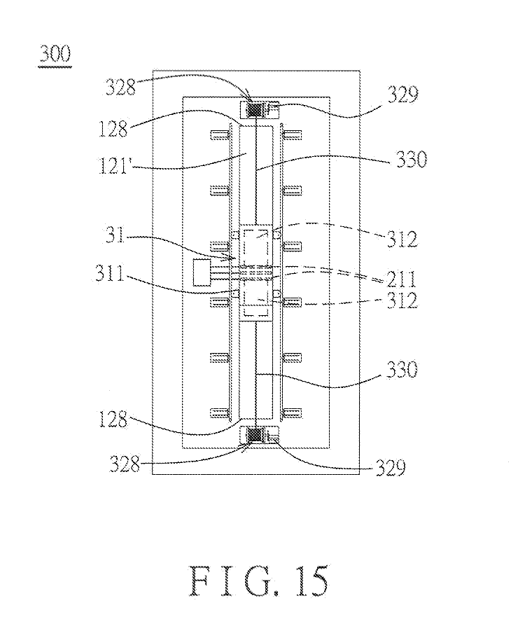

FIG. 15 illustrates an electricity generating device 300 according to the third preferred embodiment of the present invention. The entire structure and operating principle of the electricity generating device 300 are similar to that described in the second preferred embodiment. The difference resides in the number of the sliders 31.

In this embodiment, only one slider 31 is provided. The another ends of the ropes 330 of the winding devices 328 are respectively connected to two opposite ends of the slider body 311 of the slider 31 that face the short sides 128 of the track plate 121′. Because the ropes 330 can move the slider 31 linearly and reciprocally along the track plate 121′, the rollers 312 of the slider 31 can repeatedly roll over the contact pressure members 211.

In summary, because the drive assembly 32 can drive the slider(s) 31 to continuously move along the track 12, 12′ so as to repeatedly roll over the contact pressure members 211 of the contact pressure assembly 21, the electricity generating module 22 of the electricity generating device 100, 200, 300 in each embodiment can continuously and stably generate electricity. Hence, stability of storing or supplying electricity can be effectively enhanced. Additionally, the electricity generating device 100, 200, 300 generates mechanical energy through the slider(s) 31 of the kinetic mechanism 3 that continuously moves along the track 12, 12′ and that repeatedly rollover the contact pressure members 211, so that the electricity generating device 100, 200, 300 can continuously and stably generate mechanical energy and electrical energy without being affected by external environmental factors. Therefore, the electricity generating device 100, 200, 300 can be disposed where required without geographic restrictions. Therefore, the objects of the present invention can be realized.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. An electricity generating device comprising:
a base including a track;
an electricity generating mechanism including a contact pressure assembly disposed on said track, and an electricity generating module disposed on said base and connected to said contact pressure assembly, said electricity generating module being configured to convert mechanical energy generated by said contact pressure assembly into electrical energy; and
a kinetic mechanism including at least one slider disposed on said track, and a drive assembly connected to said slider for driving said slider to continuously move along said track;
wherein said slider repeatedly rolls over said contact pressure assembly when driven by said drive assembly to continuously move along said track.

2. The electricity generating device of claim 1, wherein said track includes a flat track plate, said contact pressure assembly being disposed on said flat track plate, said slider including a plurality of rollers in contact with said flat track plate, each said roller rolling over said contact pressure assembly when said slider is driven by said drive assembly to move along said track.

3. The electricity generating device of claim 2, wherein said kinetic mechanism includes a plurality of said sliders arranged along the length of said flat track plate and being driven by said drive assembly to continuously move along the length of said flat track plate.

4. The electricity generating device of claim 2, wherein said flat track plate is circular, said slider further including a slider body connected with said rollers, said drive assembly including a driven unit connected to said slider body, a drive member connected to said driven unit, and a drive motor to drive rotation of said drive member, said drive member driving rotation of said driven unit when driven by said drive motor so as to move said slider along the length of said flat track plate.

5. The electricity generating device of claim 4, wherein said drive member is a sprocket wheel, and said driven unit includes a driven member in the form of a sprocket chain which is engaged with said sprocket wheel.

6. The electricity generating device of claim 5, wherein said driven unit further includes an inner ring member connected to an inner side of said slider body, said driven member being fixed to said inner ring member, said kinetic mechanism further including an outer ring member connected to an outer side of said slider body, said track further including a plurality of inner guide members arranged angularly spaced apart from each other on said base, and a plurality of outer guide members arranged angularly spaced apart from each other on said base, said inner guide members being in contact with said inner ring member to guide a rotational direction of said inner ring member, said outer guide members being in contact with said outer ring member to guide a rotational direction of said outer ring member.

7. The electricity generating device of claim 6, wherein each said inner guide member includes an inner guide wheel in rolling contact with said inner ring member, and each said outer guide member includes an outer guide wheel in rolling contact with said outer ring member.

8. The electricity generating device of claim 7, wherein said kinetic mechanism includes a plurality of said sliders arranged angularly spaced apart from each other along the length of said flat track plate, and a plurality of connectors each pivoted to and disposed between said slider bodies of each two adjacent ones of said sliders.

9. The electricity generating device of claim 3, wherein said flat track plate is circular, each said slider including a slider body connected with said rollers, said drive assembly including a driven unit connected to said slider bodies of said sliders, a drive member connected to said driven unit, and a drive motor to drive rotation of said drive member, said drive member driving rotation of said driven unit when driven by said drive motor so as to move said sliders along the length of said flat track plate.

10. The electricity generating device of claim 9, wherein said drive member is a sprocket wheel, and said driven unit includes a driven member in the form of a sprocket chain which is engaged with said sprocket wheel.

11. The electricity generating device of claim 10, wherein said driven unit further includes an inner ring member connected to inner sides of said slider bodies, said driven member being fixed to said inner ring member, said kinetic mechanism further including an outer ring member connected to outer sides of said slider bodies, said track further including a plurality of inner guide members arranged angularly spaced apart from each other on said base, and a plurality of outer guide members arranged angularly spaced apart from each other on said base, said inner guide members being in contact with said inner ring member to guide a rotational direction of said inner ring member, said outer guide members being in contact with said outer ring member to guide a rotational direction of said outer ring member.

12. The electricity generating device of claim 11, wherein each said inner guide member includes an inner guide wheel in rolling contact with said inner ring member, and each said outer guide member includes an outer guide wheel in rolling contact with said outer ring member.

13. The electricity generating device of claim 9, wherein said kinetic mechanism further includes a plurality of connectors each pivoted to and disposed between said slider bodies of each two adjacent ones of said sliders.

14. The electricity generating device of claim 2, wherein said flat track plate is elongated and includes two opposite short sides, said slider further including a slider body connected with said rollers, said drive assembly including two winding devices respectively proximate to said short sides, and two drive motors, each said winding device being wound with a rope, said rope of each said winding device having one end wound thereon, and another end connected to one end of said slider body, each said drive motor driving rotation of a respective said winding device to move said slider along said flat track plate.

15. The electricity generating device of claim 14, wherein said contact pressure assembly is located in the middle of said flat track plate and is spaced apart from said short sides, said flat track plate further including two long sides connected by said short sides, said slider further including two side guide wheels disposed on two opposite sides of said slider body, said track further including two side guide assemblies respectively proximate to said long sides, said side guide assemblies being in contact with said side guide wheels to guide a moving direction of said slider.

16. The electricity generating device of claim 15, wherein each said side guide assembly includes a guide rod parallel to a respective said long side, and a plurality of support frames supporting said guide rod, each said side guide wheel being in rolling contact with said guide rod of a respective said side guide assembly.

17. The electricity generating device of claim 2, wherein said flat track plate is elongated and includes two opposite short sides, said kinetic mechanism including two said sliders disposed spaced apart from each other on said flat track plate, and a connector, each said slider further including a slider body connected with said rollers, said connector being connected between said slider bodies of said sliders, said drive assembly including two winding devices respectively proximate to said short sides, and two drive motors, each said winding device being wound with a rope, said rope of each said winding device having one end wound thereon, and another end connected to one end of said slider body of a respective said slider opposite to said connector, each said drive motor driving rotation of a respective said winding device to move said sliders along said flat track plate.

18. The electricity generating device of claim 17, wherein said contact pressure assembly is located in the middle of said flat track plate and is spaced apart from said short sides, said flat track plate further including two long sides connected by said short sides, each said slider further including two side guide wheels disposed on two opposite sides of said slider body, said track further including two side guide assemblies respectively proximate to said long sides, said side guide assemblies being in contact with said side guide wheels to guide a moving direction of each said slider.

19. The electricity generating device of claim 18, wherein each said side guide assembly includes a guide rod parallel to a respective said long side, and a plurality of support frames supporting said guide rod, each said side guide wheel being in rolling contact with said guide rod of a respective said side guide assembly.
